(19) United States
(12) Patent Application Publication
(10) Pub. No.: US 2009/0304989 A1
(43) Pub. Date: Dec. 10, 2009

(54) RESILIENT PLATE FOR LENS ACTUATOR

(75) Inventor: Chau-Yuan Ke, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/249,598

(22) Filed: Oct. 10, 2008

(30) Foreign Application Priority Data
Jun. 10, 2008 (CN) 200810302076.4

(51) Int. Cl. B32B 3/10

(52) U.S. Cl. 428/131

(57) ABSTRACT

A resilient plate includes a plate shaped body, a through hole defined in the center of the plate shaped body, a plurality of main slots defined in the plate shaped body and, a plurality of resilient portion and a plurality of resilient portions. The main slots cooperatively surround the through hole and are oriented an angle with respect to each other. Each of the resilient portions is arranged between two neighboring main slots. Each of the auxiliary slots is defined in each of the resilient portions.

### CROSS REFERENCE TO RELATED APPLICATION

This application is related to a commonly-assigned copending application Ser. No. 12/192,376, entitled “resilient plate and lens actuator with same” (attorney docket number US 18868). Disclosures of the above-identified application are incorporated herein by reference.

### BACKGROUND

1. Technical Field

The present invention relates to lens actuators, and particularly, to a resilient plate used in a voice coil motor type lens actuator.

2. Description of Related Art

Variable focal length lenses are widely used in optical systems. Optical systems incorporating such lenses can, for example, provide focused images of objects at varying distances without adjusting the distance between the lens and the image plane. Variable focal length lenses can also be used in optical systems that provide varying magnification without change of lenses.

Generally, the optical system usually includes an actuator, such as a step motor, to drive the lenses. However, the step motor is relatively large in volume. Use of the step motor requires a significant amount of space for movement of the lenses, which makes the optical system bulky.

Therefore, what is needed is a lens actuator adapted for driving the lenses with more compact structure and less mechanical movement.

### SUMMARY

A resilient plate includes a plate shaped body, a through hole defined in the center of the plate shaped body, a plurality of main slots defined in the plate shaped body, a plurality of resilient portions each defining an auxiliary portion therein. The main slots cooperatively surround the through hole and are oriented an angle with respect to each other. Each of the resilient portions is arranged between two neighboring main slots.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a schematic, isometric view of a lens actuator according to a first embodiment of the present invention, the lens actuator including a bracket, a movable unit, and a resilient plate.

FIG. 2 is an exploded view of the lens actuator in FIG. 1.

FIG. 3 is a schematic, isometric view of the bracket in FIG. 2.

FIG. 4 is a schematic, isometric view of the movable unit in FIG. 2.

FIG. 5 is a top view of the resilient plate in FIG. 2.

FIG. 6 is a top view of a resilient plate according to a second embodiment of the present invention.

### DETAILED DESCRIPTION OF THE EMBODIMENTS

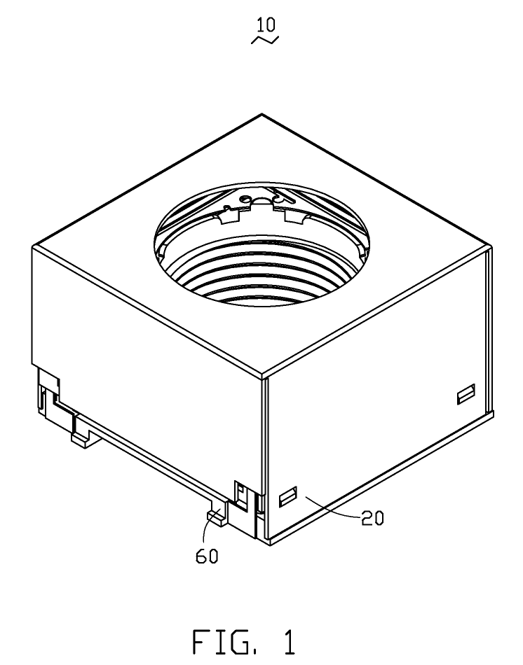

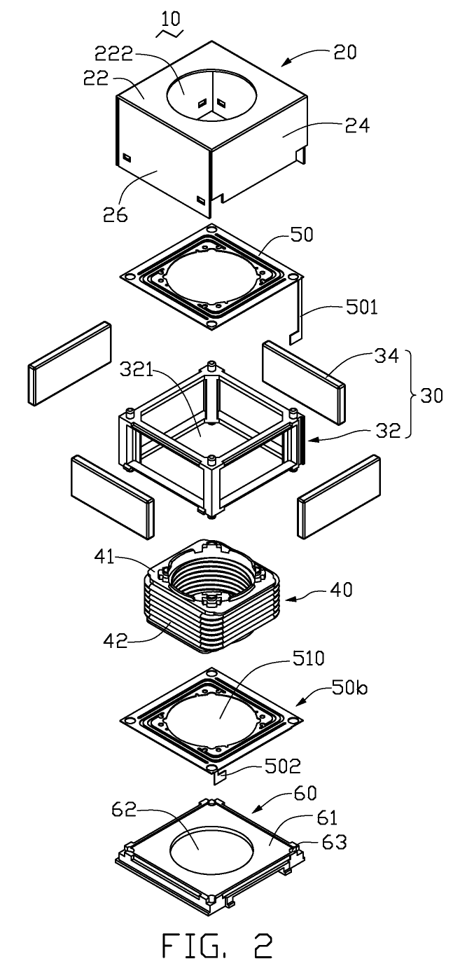

Referring to FIGS. 1 and 2, a lens actuator 10, in accordance with a first embodiment, includes a housing 20, a fixed unit 30, a movable unit 40, two resilient plates (50, 50a), and a board 60.

The housing 20 includes a panel 22, a through hole 222 defined in the center of the panel 22, two opposite first peripheral panels 24 and two opposite second peripheral panels 26 respectively perpendicularly extending from four sides of the panel 22 and fastened to one another by a dovetail panel joint (not shown). The panel 22, the first peripheral panels 24, and the second peripheral panels 26 cooperatively define a cavity for accommodating the fixed unit 30. The housing 20 is an electromagnetic shield material, such as nick alloy, conductive plastic, surface conductive material, conductive glass, etc.

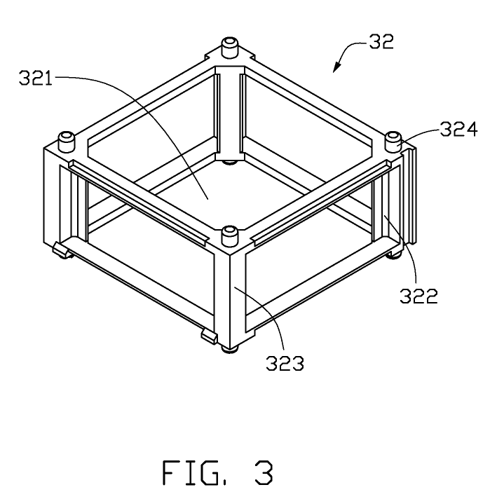

The fixed unit 30 includes a cubic bracket 32 and a plurality of magnets 34. The bracket 32 includes a frame body 323 (refer to FIG. 3) receivable in the housing 20. A first accommodation room 321 is defined in the frame body 323. Four magnet mounting holes 322 are respectively formed in four sides of the frame body 323. The magnet mounting holes 322 are in communication with the first accommodation room 321. Four first locating pins 324 are respectively vertically protruded from the top and bottom sides of the frame body 21 at each corner thereof. The first locating pins 324 are configured for fastening the fixed unit 30 to one of the resilient plates (50, 50a). The number of the magnets 34 corresponds to that of the magnet mounting holes 322. The magnets 34 are respectively mounted in the magnet mounting holes 322.

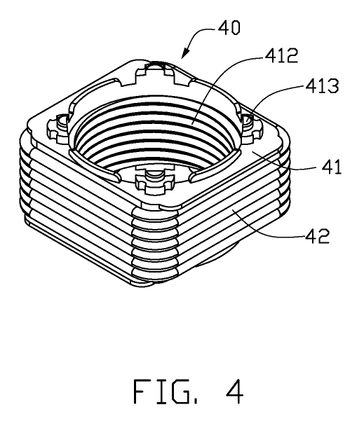

Referring to FIG. 4, the movable unit 40 includes a lens barrel 41 and coils 42. The movable unit 40 is accommodated in the first accommodating room 321 of the bracket 32. The lens barrel 41 defines a second accommodating room 412 for accommodating the lenses and filters (not shown). The second accommodating room 412 is a through hole. A second locating pin 413 is protruded from the top surface of the lens barrel 41. The coils 42 are wrapped around the side wall of the lens barrel 41.

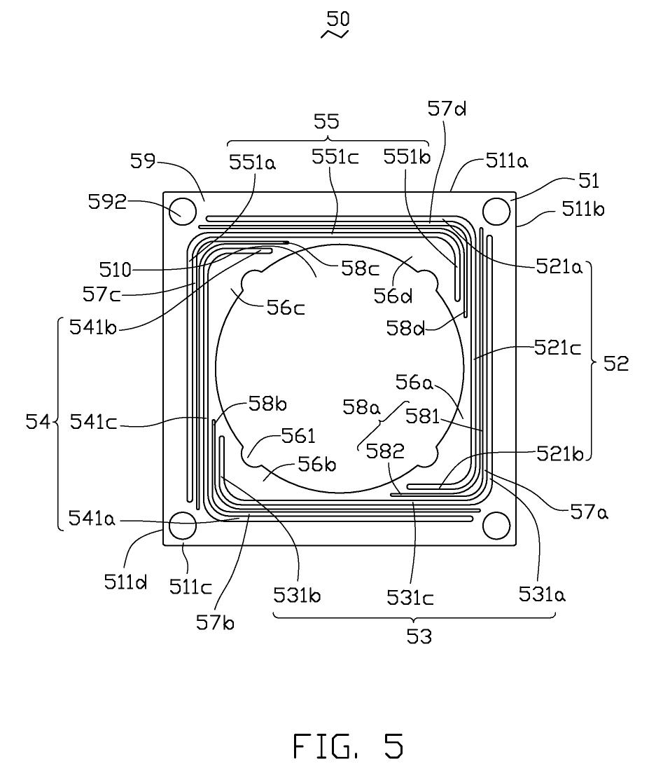

Referring to FIG. 5, the first resilient plate 50 comprises a plate shaped body 51. In the present embodiment, the plate shaped body 51 is square shaped. The plate shaped body 51 includes a first edge 511a, a second edge 511b, a third edge 511c, and a fourth edge 511d. The first edge 511a is parallel to the third edge 511c, and the second edge 511b is parallel to the fourth edge 511d. A second through hole 510 for light passing therethrough is defined at the center of the plate shaped body 51. A first slot 52, a second slot 53, a third slot 54 and a fourth slot 55 are defined in the plate shaped body 51 surrounding the second through hole 510. The slots (52, 53, 54, 55) are oriented about 90 degrees with respect to each other.

The first slot 52 includes a first starting portion 521a, a first ending portion 521b, and a first connecting portion 521c. The first starting portion 521a is parallel to the first edge 511a. The first ending portion 521b is parallel to the third edge 511c. The first connecting portion 521c is parallel to the second edge 511b and connected with the first starting portion 521a and the first ending portion 521b. The length of the first ending portion 521b is less than or equal to that of the first starting portion 521a. A first fixing portion 56a is formed between the second through hole 510 and the angular part or space between the first ending portion 521b and the first connecting portion 521c.

The second slot 53 includes a second starting portion 531a, a second ending portion 531b, and a second connecting portion 531c. The second starting portion 531a is parallel to the second edge 511b. The second ending portion 531b is parallel to the fourth edge 511d. The second connecting portion 531c is parallel to the third edge 511c and connected with the second starting portion 531a and the second ending portion 531b. The length of the second ending portion 531b is less than or equal to that of the second starting portion 531a. A second fixing portion 56b is formed between the second through hole 510 and the angular part or space between the second ending portion 531b and the second connecting portion 531c. The second starting portion 531a and the second connecting portion 531c are on the outer side of the first slot 52, i.e., the second starting portion 531a and the second connecting portion 531c are closer to the second edge 511b and the third edge 511c than the first slot 52. A first L-shaped resilient portion 57a is arranged between the first slot 52 and the second slot 53. The resilient portion 57a has a uniform width throughout the length thereof. A first L-shaped slot 58a is defined in the middle of the first L-shaped resilient portion 57a. The first L-shaped slot 58a includes a first portion 581 and a second portion 582. The first portion 581 is parallel to the second starting portion 531a. The second portion 582 is parallel to the second connecting portion 531c. The first L-shaped slot 58a also can only include a first portion 581. Since the L-shaped resilient portion 57a has an angular part or space, the durability and flexibility of the first resilient plate 50 is enhanced.

The third slot 54 includes a third starting portion 541a, a third ending portion 541b, and a third connecting portion 541c. The third starting portion 541a is parallel to the third edge 511c. The third ending portion 541b is parallel to the first edge 511a. The third connecting portion 541c is parallel to the fourth edge 51Id and connected with the third starting portion 541a and the third ending portion 541b. The length of the third ending portion 541b is less than or equal to that of the third starting portion 541a. A third fixing portion 56c is formed between the second through hole 510 and the angular part or space between the third ending portion 541b and the third connecting portion 541c. The third starting portion 541a and the third connecting portion 541c are on the outer side of the second slot 53, i.e., the third starting portion 541a and the third connecting portion 541c are closer to the third edge 511c and the fourth edge 511d than the second slot 53. A second L-shaped resilient portion 57b is formed between the second slot 53 and the third slot 54. A second L-shaped slot 58b with same structure of the first L-shaped slot 58a is defined in the middle of the second L-shaped resilient portion 57b.

The fourth slot 55 includes a fourth starting portion 551a, a fourth ending portion 551b, and a fourth connecting portion 551c. The fourth starting portion 551a is parallel to the fourth edge 511d. The fourth ending portion 551b is parallel to the second edge 511b. The fourth connecting portion 551c is parallel to the first edge 511a and connected with the fourth starting portion 551a and the fourth ending portion 551b. The length of the fourth ending portion 551b is less than or equal to that of the fourth starting portion 551a. A fourth fixing portion 56d is formed between the second through hole 510 and the angular part or space between the fourth ending portion 551b and the fourth connecting portion 551c. The fourth starting portion 551a and the fourth connecting portion 551c are on the outer side of the third slot 54, i.e., the fourth starting portion 551a and the fourth connecting portion 551c are closer to the fourth edge 511d and the first edge 511a than the third slot 54. A third L-shaped resilient portion 57c is formed between the third slot 54 and the fourth slot 55. A third L-shaped slot 58c with same structure of the first L-shaped slot 58a is defined in the middle of the third L-shaped resilient portion 57c. The first starting portion 521a and the first connecting portion 521c are on the outer side of the fourth slot 55, i.e., the first starting portion 521a and the first connecting portion 521c are closer to the first edge 511d and the first edge 511a than the fourth slot 55. A fourth L-shaped resilient portion 57d is formed between the fourth slot 55 and the first slot 52. A fourth L-shaped slot 58d with same structure of the first L-shaped slot 58a is defined in the middle of the third L-shaped resilient portion 57d.

Each fixing portion (56a, 56b, 56c, 56d) defines a first cutout 561 in the edge of the second through hole 510 corresponding to the respective second locating pins 413.

A periphery portion 59 is formed between the edges (511a, 511b, 511c and 511d) and the starting portions (521a, 531a, 541a and 551a). Four holes 592 corresponding to the respective first locating pins 324 are defined in the periphery portion 59 in four corners. The first resilient plate 50 is fastened to the bottom side of the bracket 32 by engagement of the holes 592 with the respective first locating pins 324.

The board 60 comprises a body 61 covered over the second resilient plate 50a on the top side of the housing 30, an through hole 62 corresponding to the second accommodating room 412 of the lens barrel 41, four holes 63 respectively fastened to the first locating pins 324 at the top side of the bracket 32.

When an electric current is applied to the coils 42, the coils 42 are excited to act upon the magnets 34, thereby producing a magnetic force to drive the lens barrel 42 to move between the first resilient plate 50 and the second resilient plate 50a.

When electric current is cut off, the first resilient plate 50 and the second resilient plate 50a impart a pressure to the lens barrel 41 relative to the bracket 32, thereby returning the lens barrel 41 to its former position.

Further, the housing 20 and the board 60 protect the lens barrel and image sensor (not shown) against dust.

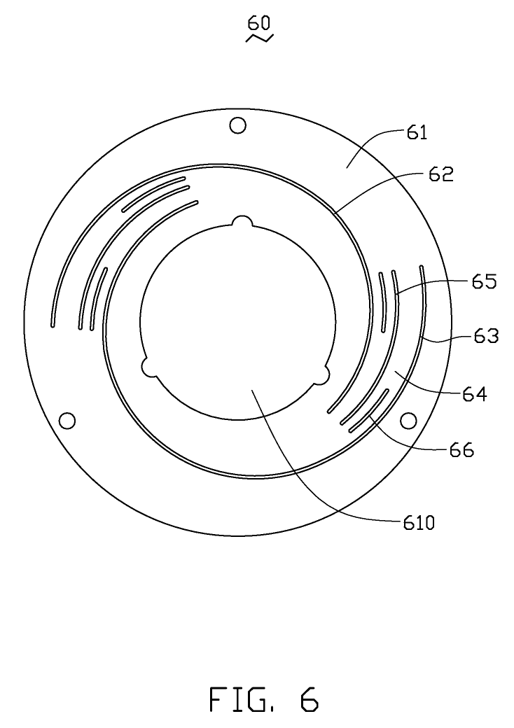

Referring to FIG. 6, a resilient plate 60, in accordance with a second embodiment, includes a plate shaped body 61. In the present embodiment, the plate shaped body 61 is disk shaped. A through hole 610 for light passing therethrough is defined at the center of the plate shaped body 61. A first arc-shaped slot 62 and a second arc-shaped slot 63 are defined in the plate shaped body 61 surrounding the second through hole 610. The arc-shaped slots (62, 63) are oriented about 180 degrees with respect to each other. Two arc-shaped resilient portions 64 are respectively arranged between two distal ends of the first arc-shaped slot 62 and the second arc-shaped slot 63. Two third arc-shaped slot 65 are respectively defined in the middle of each of the arc-shaped resilient portions 64. In the present embodiment, the extending direction of the third arc-shaped slot 65 is substantially parallel to the neighboring arc-shaped slot 62 or 63. It is understood that, more slots, such as a forth arc-shaped slot 66 can be defined between the third slot 65 and the arc-shaped slot 63 or 62 as shown in FIG. 6. The forth arc-shaped slot 66 can be communicated with the third arc-shaped slot 65, the first arc-shaped slot 62, or the second arc-shaped slot 63. The length of the forth arc-shaped slot 66 can be more than or equal to that of the third arc-shaped slot 65.

While certain embodiments have been described and exemplified above, various other embodiments will be apparent to those skilled in the art from the foregoing disclosure. The present invention is not limited to the particular embodiments described and exemplified but is capable of considerable variation and modification without departure from the scope of the appended claims.

What is claimed is:

1. A resilient plate comprising:
a plate shaped body comprising
a through hole defined in the center of the plate shaped body,
a plurality of main slots defined in the plate shaped body and, the main slots cooperatively surrounding the through hole and being oriented an angle with respect to each other,
a plurality of resilient portions, each of the resilient portions being arranged between two neighboring main slots, and
a plurality of auxiliary slots, each of the auxiliary slots being defined in the respective resilient portion.

2. The resilient plate as claimed in claim 1, wherein each of the main slots includes a first substantially straight slot portion, a second substantially straight slot portion and a third substantially straight slot portion, the second substantially straight slot portion interconnects between and substantially perpendicular to the first and second substantially straight slot portions, the main slots being oriented about 90 degrees with respect to each other.

3. The resilient plate as claimed in claim 2, wherein the plate shaped body is substantially a square plate.

4. The resilient plate as claimed in claim 3, wherein the plate shaped body includes a first edge, a second edge, a third edge, and a fourth edge, the first edge is substantially parallel to the third edge, and the second edge is substantially parallel to the fourth edge.

5. The resilient plate as claimed in claim 4, wherein the resilient portions are L-shaped resilient portions, each L-shaped resilient portion arranged between two neighboring main slots.

6. The resilient plate as claimed in claim 5, wherein each L-shaped resilient portion has a uniform width throughout the length thereof.

7. The resilient plate as claimed in claim 5, wherein a length of the third substantially straight slot portion of each main slot is less than or equal to a length of the first substantially straight slot portion.

8. The resilient plate as claimed in claim 7, wherein the plate shaped body comprises a plurality of fixing portions, each of the fixing portions is located between the through hole and the junction portion of the second and third substantially straight slot portions of the corresponding main slot.

9. The resilient plate as claimed in claim 5, wherein the plurality of the main slots comprises a first main slot, a second main slot, a third main slot, and a fourth main slot, the first substantially straight portion of the first main slot is substantially parallel to the first edge, the second substantially straight portion of the first main slot is substantially parallel to the second edge, the first substantially straight portion of the second main slot is substantially parallel to the second edge, the second substantially straight portion of the second main slot is substantially parallel to the third edge, the first substantially straight portion of the third main slot is substantially parallel to the third edge, the second substantially straight portion of the third main slot is substantially parallel to the fourth edge, and the first substantially straight portion of the fourth main slot is substantially parallel to the fourth edge, the second substantially straight portion of the third main slot is substantially parallel to the first edge.

10. The resilient plate as claimed in claim 2, wherein each of the auxiliary slots comprises a first substantially straight slot portion and a second substantially straight slot portion, the first substantially straight slot portion of the auxiliary slot is substantially parallel with the first substantially straight slot portion of the neighboring main slot, and the second substantially straight slot portion of the auxiliary slot is substantially parallel with the second substantially straight slot portion of the neighboring main slot.

11. The resilient plate as claimed in claim 2, wherein each of the auxiliary slots is a substantially straight slot substantially parallel with the second substantially straight slot portion of the neighboring main slot.

12. The resilient plate as claimed in claim 1, wherein each of the main slots is arc-shaped, the main slots being oriented about 180 degrees with respect to each other.
